(19) United States
(12) Patent Application Publication
(10) Pub. No.: US 2014/0269768 A1
(43) Pub. Date: Sep. 18, 2014

(54) METHODS AND APPARATUS FOR INCREASING DIVERSITY IN DOWNLINK TRANSMISSIONS

(71) Applicant: QUALCOMM INCORPORATED, San Diego, CA (US)

(72) Inventors: Sameer Vermani, San Diego, CA (US); Bin Tian, San Diego, CA (US); Albert va Zelst, Woerden (NL)

(73) Assignee: QUALCOMM Incorporated, San Diego, CA (US)

(21) Appl. No.: 13/826,014

(22) Filed: Mar. 14, 2013

(51) Int. Cl. H04B 7/06; H04L 29/06

(52) U.S. Cl. CPC H04B 7/0613; H04L 69/22
USPC 370/474

(57) ABSTRACT

Certain aspects of the present disclosure provide methods and apparatus for obtaining second-order downlink spatial diversity within a wireless communication system in accordance with IEEE 802.11ah, for example. One example method generally includes generating a frame comprising a preamble having at least one field, replicating at least one bit of the at least one field to form a replica of the at least one bit, transmitting the at least one bit via a first antenna, and transmitting the replica of the at least one bit via a second antenna. Another example method generally includes generating at least two space-time streams; transmitting, via a first pair of antennas, the at least two space-time streams in a first frequency band; and transmitting, via a second pair of antennas, the at least two space-time streams in a second frequency band.

### BACKGROUND

1. Field of the Invention

Certain aspects of the present disclosure generally relate to wireless communications and, more particularly, to increasing diversity in downlink (DL) transmissions.

2. Relevant Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than other IEEE 802.11 groups and has lower obstruction losses.

### SUMMARY

Certain aspects of the present disclosure provide an apparatus for wireless communications. The apparatus typically includes a first antenna, a second antenna, a processing system, and a transmitter. The processing system is generally configured to generate a frame comprising a preamble having at least one field and to replicate at least one bit of the at least one field to form a replica of the at least one bit. The transmitter is generally configured to transmit the at least one bit via the first antenna and to transmit the replica of the at least one bit via the second antenna.

Certain aspects of the present disclosure provide a method for wireless communications. The method generally includes generating a frame comprising a preamble having at least one field, replicating at least one bit of the at least one field to form a replica of the at least one bit, transmitting the at least one bit via a first antenna, and transmitting the replica of the at least one bit via a second antenna.

Certain aspects of the present disclosure provide an apparatus for wireless communications. The apparatus generally includes means for generating a frame comprising a preamble having at least one field, means for replicating at least one bit of the at least one field to form a replica of the at least one bit, means for transmitting the at least one bit via a first antenna, and means for transmitting the replica of the at least one bit via a second antenna.

Certain aspects of the present disclosure provide a computer-program product for wireless communications. The computer-program product generally includes a computer-readable medium having instructions executable to generate a frame comprising a preamble having at least one field; to replicate at least one bit of the at least one field to form a replica of the at least one bit; to transmit the at least one bit via a first antenna; and to transmit the replica of the at least one bit via a second antenna.

Certain aspects of the present disclosure provide an access point. The access point generally includes a first antenna, a second antenna, a processing system, a memory component, and a transmitter. The processing system is generally configured to generate a frame comprising a preamble having at least one field and to replicate at least one bit of the at least one field to form a replica of the at least one bit. The transmitter is generally configured to transmit the at least one bit via the first antenna and to transmit the replica of the at least one bit via the second antenna. The memory component is typically configured to store the frame before transmission.

Certain aspects of the present disclosure provide an apparatus for wireless communications. The apparatus generally includes a first antenna, a second antenna, a processing system, and a transmitter. The processing system is typically configured to generate a frame comprising a preamble having at least one field and to replicate at least one bit of the at least one field to form a replica of the at least one bit. The transmitter is typically configured to transmit, via the first and second antennas, the at least one bit at a first frequency; to transmit, via the first antenna, the replica of the at least one bit at a second frequency; and to transmit, via the second antenna, a negative of the replica of the at least one bit at the second frequency.

Certain aspects of the present disclosure provide a method for wireless communications. The method generally includes generating a frame comprising a preamble having at least one field; replicating at least one bit of the at least one field to form a replica of the at least one bit; transmitting, via a first antenna and a second antenna, the at least one bit at a first frequency; transmitting, via the first antenna, the replica of the at least one bit at a second frequency; and transmitting, via the second antenna, a negative of the replica of the at least one bit at the second frequency.

Certain aspects of the present disclosure provide an apparatus for wireless communications. The apparatus generally includes means for generating a frame comprising a preamble having at least one field; means for replicating at least one bit of the at least one field to form a replica of the at least one bit; means for transmitting, via a first antenna and a second antenna, the at least one bit at a first frequency; means for transmitting, via the first antenna, the replica of the at least one bit at a second frequency; and means for transmitting, via the second antenna, a negative of the replica of the at least one bit at the second frequency.

Certain aspects of the present disclosure provide a computer-program product for wireless communications. The computer-program product generally includes a computer-readable medium having instructions executable to generate a frame comprising a preamble having at least one field; to replicate at least one bit of the at least one field to form a replica of the at least one bit; to transmit, via a first antenna and a second antenna, the at least one bit at a first frequency; to transmit, via the first antenna, the replica of the at least one bit at a second frequency; and to transmit, via the second antenna, a negative of the replica of the at least one bit at the second frequency.

Certain aspects of the present disclosure provide an access point. The access point generally includes a first antenna, a second antenna, a processing system, a memory component, and a transmitter. The processing system is typically configured to generate a frame comprising a preamble having at least one field and to replicate at least one bit of the at least one field to form a replica of the at least one bit. The transmitter is typically configured to transmit, via the first and second antennas, the at least one bit at a first frequency; to transmit, via the first antenna, the replica of the at least one bit at a second frequency; and to transmit, via the second antenna, a negative of the replica of the at least one bit at the second frequency. The memory component is generally configured to store the frame before transmission.

Certain aspects of the present disclosure provide an apparatus for wireless communications. The apparatus generally includes a first pair of antennas, a second pair of antennas, a processing system, and a transmitter. The processing system is typically configured to generate at least two space-time streams. The transmitter is generally configured to transmit, via the first pair of antennas, the at least two space-time streams in a first frequency band; and to transmit, via the second pair of antennas, the at least two space-time streams in a second frequency band.

Certain aspects of the present disclosure provide a method for wireless communications. The method generally includes generating at least two space-time streams; transmitting, via a first pair of antennas, the at least two space-time streams in a first frequency band; and transmitting, via a second pair of antennas, the at least two space-time streams in a second frequency band.

Certain aspects of the present disclosure provide an apparatus for wireless communications. The apparatus generally includes means for generating at least two space-time streams; means for transmitting, via a first pair of antennas, the at least two space-time streams in a first frequency band; and means for transmitting, via a second pair of antennas, the at least two space-time streams in a second frequency band.

Certain aspects of the present disclosure provide a computer program product for wireless communications. The computer program product generally includes a computer-readable medium having instructions executable to generate at least two space-time streams; to transmit, via a first pair of antennas, the at least two space-time streams in a first frequency band; and to transmit, via a second pair of antennas, the at least two space-time streams in a second frequency band.

Certain aspects of the present disclosure provide an access point. The access point generally includes a first pair of antennas, a second pair of antennas, a processing system, a memory component, and a transmitter. The processing system is typically configured to generate at least two space-time streams. The transmitter is generally configured to transmit, via the first pair of antennas, the at least two space-time streams in a first frequency band; and to transmit, via the second pair of antennas, the at least two space-time streams in a second frequency band. The memory component is typically configured to store the at least two space-time streams before transmission.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates an example physical layer conversion protocol (PLCP) protocol data unit (PPDU) format, in accordance with certain aspects of the present disclosure.

FIG. 4 illustrates an example block diagram of a transmission flow for MCS0-Rep2 mode, in accordance with certain aspects of the present disclosure.

FIG. 5 illustrates an example plot of cumulative distribution functions (CDFs) of post processing signal-to-noise ratios (SNRs) for different transmission schemes, in accordance with certain aspects of the present disclosure.

FIG. 6 illustrates a flow diagram of example operations for transmitting bits and their replicas on different antennas, in accordance with certain aspects of the present disclosure.

FIG. 6A illustrates example means capable of performing the operations shown in FIG. 6.

FIG. 7 illustrates a flow diagram of example operations for transmitting bits and their replicas by multiplying with different vectors, in accordance with certain aspects of the present disclosure.

FIG. 7A illustrates example means capable of performing the operations shown in FIG. 7.

FIG. 8 illustrates a flow diagram of example operations for transmitting at least two space-time streams using at least two pairs of antennas, in accordance with certain aspects of the present disclosure.

FIG. 8A illustrates example means capable of performing the operations shown in FIG. 8.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The SDMA system may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal

On the uplink, at each user terminal 120 selected for uplink transmission, a transmit (TX) data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

### Example Packet Format

FIG. 3 illustrates an example physical layer conversion protocol (PLCP) protocol data unit (PPDU) format 300 in accordance with certain wireless communication standards, such as the IEEE 802.11ah amendment to the 802.11 standard. The PPDU comprises a preamble portion and a data portion 310. Providing the manner in which the data portion 310 is communicated and used for relaying control information, the preamble portion includes a short training field (STF) 302, a long training field (LTF) 304, a signal (SIG) field 306, and one or more additional LTFs 308 (e.g., LTF1).

The STF 302 may be used for packet detection, coarse frequency synchronization, and setting the gain of an automatic gain control (AGC) unit in order to process the PPDU. The LTF 304 is used for channel estimation and fine frequency synchronization. The SIG field 306 typically provides various control information, such as the modulation and coding scheme (MCS) used for the data portion 310. The additional LTFs 308 correspond to the number of spatial streams (Nsts) in the data. With this information from the preamble portion, a wireless apparatus receiving the PPDU can process the data accordingly.

### Example Diversity Gain on the SIG Field

Diversity (also known as antenna diversity or spatial diversity) in wireless communication systems involves the use of two more antennas from a transmitting or receiving device to increase the quality and reliability of wireless channels. Diversity gain may be defined as the increase in effective signal-to-interference-plus-noise ratio (SINR) at a given error rate due to a diversity scheme—or how much the transmission power can be reduced if a diversity scheme is introduced—without a performance loss.

Diversity gain is extremely crucial in lower bandwidths (BWs), such as 1 MHz. In channel D non-line-of-sight (D-NLOS) models at 1 MHz, up to 7-8 dB of diversity gain is offered in going from 1 antenna to 2 antennas. In the uplink (UL), receive beamforming (BF) can provide diversity gain and array gain. For the downlink (DL), space-time block coding (STBC) can provide diversity gain during the data portion 310 of a PPDU, but traditionally the SIG field 306 in the preamble of the PPDU is not sent using STBC. Typical cyclic shift diversity (CSD) on the SIG field does not provide the full 2nd-order diversity gain, and STBC cannot be used as a range extension technique in its current form. This all leads to a substantial difference between the ranges of UL and DL transmissions.

Accordingly, what is needed are techniques and apparatus to achieve diversity gain on the SIG field.

Certain aspects of the present disclosure provide 2^{nd}-order diversity gain for a repetition-coded 1 MHz SIG field. For 1 MHz channels in IEEE 802.11ah, for example, the SIG field is sent using MCS0-Rep2 (i.e., a modulation and coding scheme (MCS) having index 0, which indicates binary phase-shift keying (BPSK) with a coding rate of ½, in which two replicas of the same coded bit are sent on 2 tones).

FIG. 4 illustrates an example block diagram 400 of a transmission flow for the MCS0-Rep2 mode, in accordance with certain aspects of the present disclosure. The block diagram 400 includes a scrambler 402, a forward error correction (FEC) unit 404, a 2× block-wise repetition unit 406, an interleaver 408, a BPSK mapper 410, a spatial mapping unit 412, and various transmission paths. Each transmission path includes an inverse discrete Fourier transform (IDFT) unit 414, a guard interval (GI) unit 416, an analog and radio frequency (RF) front end 418, and an antenna 420. After FEC is applied by the FEC unit 404, the 2× block-wise repetition unit 406 performs block-wise repetition on a single space-time stream (Nss=1) to generate replicated bits before interleaving is applied by the interleaver 408.

Certain aspects of the present disclosure provide two options to achieve 2^{nd}-order spatial diversity gain. In a first option, one replica of a coded bit of the SIG field 306 may be sent via antenna 1, and the second replica of the coded bit may be sent via antenna 2. The first option also has an advantage when considering emissions, since one antenna is active over a smaller band. This may allow for a slightly lower power amplifier (PA) backoff. As used herein, first and second replicas refer to the output of the 2× block-wise repetition unit 406, whether or not the particular bits were actually replicated or may be considered as original bits. In a second option, one replica of a coded bit of the SIG field 306 may be sent along [1 1] as a spatial expansion (i.e., the transmission symbol may be multiplied with the vector [1 1] corresponding to the two transmission paths), whereas the second replica may be sent along [1 −1] as a spatial expansion (i.e., the transmission symbol may be multiplied with the vector [1-1] corresponding to the two transmission paths).

With either option, the receiver is oblivious to the presence of two antennas. At the receiver side, the received signals over two tones are

y1=h1*x+n1

y2=h2*x+n2
for the first option and

y1=(h1+h2)x+n1

y2=(h1−h2)x+n2

for the second option, where x represents the coded bit, h1 represents the effects of the first channel between the first transmit antenna and the receiver antenna, h2 represents the effects of the second channel between the second transmit antenna and the receiver antenna, n1 is the noise added by transmission for the first tone, n2 is the noise added by transmission for the second tone, y1 represents the coded bit x as transformed and received for the first tone, and y2 represents the coded bit x as transformed and received for the second tone. Other fields in the preamble may be sent in the same way, such as the LTF 304 to enable correct channel estimation on each tone.

For MCS0 Rep 2, the two replicas of the same coded bit lie on different sides of DC. Fortunately, this is still the case after interleaving. These options also pose no issue for 1 versus 2 MHz classification during long training fields (LTFs). One side of DC can use the same spatial expansion, thereby minimizing discontinuities.

Furthermore, in multiple antenna cases, each antenna can transmit on a subset of STF tones to get diversity gain on the STF. This technique is only useful for MCS0-Rep2 transmissions, since data is transmitted with repetition encoding to achieve diversity.

FIG. 5 illustrates an example plot 500 of cumulative distribution functions (CDFs) of capacity-averaged post processing signal-to-noise ratios (SNRs) in decibels (dBs) for different transmission schemes, assuming a D-NLOS 1 MHz channel. CDF 502 illustrates MCS0-Rep2 transmission of the SIG field using a single antenna. CDF 504 illustrates MCS0-Rep2 transmission of the SIG field using two transmit antennas, each operating with a frequency on either side of DC. A diversity gain of approximately 6 dB is illustrated at a probability of 10⁻² for CDF 504 over CDF 502.

CDF 506 illustrates MCS0-Rep2 transmission of the SIG field using three transmit antennas. In this case, the frequencies may be divided into three frequency bands. Three different antenna pairs (e.g., antenna 1 and antenna 2, antenna 2 and antenna 3, and antenna 3 and antenna 1, such that the transmit symbol is effectively multiplied by the vectors [1 1 0], [0 1 1], and [1 0 1]) may be cycled through for transmission, and each antenna pair may correspond to a different frequency band. CDF 506 illustrates even greater diversity gain over CDF 502 than CDF 504.

FIG. 6 illustrates a flow diagram of example operations 600 for transmitting bits and their replicas on different antennas, in accordance with certain aspects of the present disclosure. The operations 600 may be performed by an apparatus capable of sending downlink transmissions, such as an access point (AP) 110. More specifically, at least some of the operations 600 may be performed by the TX data processor 210, the TX spatial processor 220, the transmitter unit(s) 222, and/or the antenna(s) 224 of the AP illustrated in FIG. 2.

The operations may begin, at 602, with the apparatus generating a frame comprising a preamble having at least one field. The at least one field may include at least one of a signal (SIG) field or a short training field (STF). According to certain aspects, the frame is transmitted in a channel having a bandwidth of about 1 MHz. For certain aspects, the at least one field is transmitted using binary phase-shift keying (BPSK) and a coding rate of ½. At 604, the apparatus may replicate at least one bit of the at least one field to form a replica of the at least one bit.

At 606, the apparatus may transmit the at least one bit via a first antenna. At 608, the apparatus may transmit the replica of the at least one bit via a second antenna. According to certain aspects, transmitting the at least one bit at 606 involves transmitting, via the first antenna, the at least one bit at a first frequency, and transmitting the replica of the at least one bit at 608 involves transmitting, via the second antenna, the replica of the at least one bit at a second frequency. For certain aspects, the first frequency is above DC, and the second frequency is below DC. According to certain aspects, the frame may be stored in a memory component (e.g., a storage medium, such as the memory 232) before transmission.

According to certain aspects, the operations 600 may further include transmitting, via the first antenna, a first bit of the at least one field at the first frequency; transmitting, via the second antenna, a replica of the first bit at the first frequency; transmitting, via the second antenna, a second bit of the at least one field at a second frequency; and transmitting, via a third antenna, a replica of the second bit at the second frequency. For certain aspects, the operations 600 may also further include transmitting, via the third antenna, a third bit of the at least one field at a third frequency and transmitting, via the first antenna, a replica of the third bit at the third frequency.

FIG. 7 illustrates a flow diagram of example operations 700 for transmitting bits and their replicas by multiplying with different vectors, in accordance with certain aspects of the present disclosure. The operations 700 may be performed by an apparatus capable of sending downlink transmissions, such as an access point (AP) 110. More specifically, at least some of the operations 700 may be performed by the TX data processor 210, the TX spatial processor 220, the transmitter unit(s) 222, and/or the antenna(s) 224 of the AP illustrated in FIG. 2.

The operations may begin, at 702, with the apparatus generating a frame comprising a preamble having at least one field. The at least one field may include at least one of a SIG field or an STF. According to certain aspects, the frame is transmitted in a channel having a bandwidth of about 1 MHz. For certain aspects, the at least one field is transmitted using BPSK and a coding rate of ½. At 704, the apparatus may replicate at least one bit of the at least one field to form a replica of the at least one bit.

At 706, the apparatus may transmit, via a first antenna and a second antenna, the at least one bit at a first frequency. At 708, the apparatus may transmit, via the first antenna, the replica of the at least one bit at a second frequency and, at 710, may transmit, via the second antenna, a negative of the replica of the at least one bit at the second frequency. According to certain aspects, the first frequency is above DC, and the second frequency is below DC. According to certain aspects, the frame may be stored in a memory component (e.g., a storage medium, such as the memory 232) before transmission.

### Example Diversity Gain for STBC Transmissions Via ¾ Antennas

In IEEE 802.11ac/ah, currently, there is no single spatial stream STBC for 3 and 4 transmit (Tx) antennas. One can do spatial expansion of two space-time streams to 3 or 4 Tx antennas. However, one issue is that plain spatial expansion will result in an equivalently isotropically radiated power (EIRP) hit (due to BF effects). This may not be desirable in domains where EIRP limits are stringent. Moreover, due to 1 versus 2 MHz classification relying on smoothness of the frequency domain channel, some techniques cannot be applied during long training fields (LTFs).

Accordingly, what is needed are techniques and apparatus to make the ¾-antenna STBC transmissions look like 2×1 Alamouti to the receiver

Certain aspects of the present disclosure provide techniques for transmitting STBC streams via ¾ antennas, such that the transmissions appear as 2×1 Alamouti STBC to the receiver. For the 4 antenna case, one side of DC may use 2 of the 4 antennas, while the other side may use the 2 other antennas. The same may be done for the LTFs, and there is no issue for 1 versus 2 MHz classification during LTFs. Also, one side of DC using the same 2 antennas avoids discontinuities during LTFs.

In the case of 3 antennas, tones may be split into 3 frequency bands which use antennas (1,2), (2,3), and (3,1), respectively. This may also be done for LTFs, and again, there is no issue for 1 versus 2 MHz classification during LTFs. Just two transitions in spatial expansion should not cause an issue for the differential metric.

For these techniques, ¾-antenna STBC transmissions need not be a range extension technique. Hence the full 3^{rd}- or 4^{th}-order diversity need not be performed for the SIG field 306 for such transmissions.

FIG. 8 illustrates a flow diagram of example operations 800 for transmitting at least two space-time streams using at least two pairs of antennas, in accordance with certain aspects of the present disclosure. The operations 800 may be performed by an apparatus capable of sending downlink transmissions, such as an AP 110. More specifically, at least some of the operations 800 may be performed by the TX data processor 210, the TX spatial processor 220, the transmitter unit(s) 222, and/or the antenna(s) 224 of the AP illustrated in FIG. 2.

The operations may begin, at 802, with the apparatus generating at least two space-time streams. These space-time streams may be generated by a stream parser (e.g., a stream parsing unit located in the TX data processor 210) or another processing unit in the apparatus. At 804, the apparatus may transmit, via a first pair of antennas, the at least two space-time streams in a first frequency band. At 806, the apparatus may transmit, via a second pair of antennas, the at least two space-time streams in a second frequency band. For certain aspects, the first frequency band is above DC, and the second frequency band is below DC. According to certain aspects, the space-time streams may be stored in a memory component (e.g., a storage medium, such as the memory 232) before transmission.

According to certain aspects, the apparatus may transmit, via a third pair of antennas, the at least two space-time streams in a third frequency band. In this case, the first pair of antennas may include a first antenna and a second antenna, the second pair of antennas may include the second antenna and a third antenna, and the third pair of antennas may include the third antenna and the first antenna.

As described above, certain aspects of the present disclosure provide techniques which address the following: (1) at least second-order spatial diversity on the SIG field of 1 MHz packets; and (2) three- or four-antenna STBC stream transmissions which mimic a 2×1 STBC transmission as far as the receiver is concerned. These techniques need not involve changes to the standards (e.g., IEEE 802.11ah).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 600 illustrated in FIG. 6 correspond to means 600A illustrated in FIG. 6A.

For example, means for transmitting may comprise a transmitter (e.g., the transmitter unit 222) and/or an antenna(s) 224 of the access point 110 illustrated in FIG. 2. Means for receiving may comprise a receiver (e.g., the receiver unit 222) and/or an antenna(s) 224 of the access point 110 illustrated in FIG. 2. Means for processing, means for generating, means for replicating, or means for determining, may comprise a processing system, which may include one or more processors, such as the RX data processor 242, the TX data processor 210, the TX spatial processor 220, and/or the controller 230 of the access point 110 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a first antenna;
a second antenna;
a processing system configured to:
generate a frame comprising a preamble having at least one field; and
replicate at least one bit of the at least one field to form a replica of the at least one bit; and
a transmitter configured to:
transmit the at least one bit via the first antenna; and
transmit the replica of the at least one bit via the second antenna.

2. The apparatus of claim 1, wherein the transmitter is configured to transmit the frame in a channel having a bandwidth of about 1 MHz.

3. The apparatus of claim 1, wherein the transmitter is configured to transmit the at least one field using binary phase-shift keying (BPSK) and a coding rate of ½.

4. The apparatus of claim 1, wherein the transmitter is configured to:
transmit, via the first antenna, the at least one bit at a first frequency; and
transmit, via the second antenna, the replica of the at least one bit at a second frequency.

5. The apparatus of claim 4, wherein the first frequency is above DC and wherein the second frequency is below DC.

6. The apparatus of claim 1, wherein the apparatus further comprises a third antenna and wherein the transmitter is configured to:
transmit, via the first antenna, a first bit of the at least one field at a first frequency;
transmit, via the second antenna, a replica of the first bit at the first frequency;
transmit, via the second antenna, a second bit of the at least one field at a second frequency; and
transmit, via the third antenna, a replica of the second bit at the second frequency.

7. The apparatus of claim 6, wherein the transmitter is further configured to:
transmit, via the third antenna, a third bit of the at least one field at a third frequency; and
transmit, via the first antenna, a replica of the third bit at the third frequency.

8. The apparatus of claim 1, wherein the at least one field comprises at least one of a signal (SIG) field or a short training field (STF).

9. A method for wireless communications, comprising:
generating a frame comprising a preamble having at least one field;
replicating at least one bit of the at least one field to form a replica of the at least one bit;
transmitting the at least one bit via a first antenna; and
transmitting the replica of the at least one bit via a second antenna.

10. The method of claim 9, wherein the frame is transmitted in a channel having a bandwidth of about 1 MHz.

11. The method of claim 9, wherein the at least one field is transmitted using binary phase-shift keying (BPSK) and a coding rate of ½.

12. The method of claim 9, wherein transmitting the at least one bit comprises transmitting, via the first antenna, the at least one bit at a first frequency and wherein transmitting the replica of the at least one bit comprises transmitting, via the second antenna, the replica of the at least one bit at a second frequency.

13. The method of claim 12, wherein the first frequency is above DC and wherein the second frequency is below DC.

14. The method of claim 9, further comprising:
transmitting, via the first antenna, a first bit of the at least one field at a first frequency;
transmitting, via the second antenna, a replica of the first bit at the first frequency;
transmitting, via the second antenna, a second bit of the at least one field at a second frequency; and
transmitting, via a third antenna, a replica of the second bit at the second frequency.

15. The method of claim 14, further comprising:
transmitting, via the third antenna, a third bit of the at least one field at a third frequency; and
transmitting, via the first antenna, a replica of the third bit at the third frequency.

16. The method of claim 9, wherein the at least one field comprises at least one of a signal (SIG) field or a short training field (STF).

17. An apparatus for wireless communications, comprising:
means for generating a frame comprising a preamble having at least one field;
means for replicating at least one bit of the at least one field to form a replica of the at least one bit;
means for transmitting the at least one bit via a first antenna; and
means for transmitting the replica of the at least one bit via a second antenna.

18. The apparatus of claim 17, wherein the frame is transmitted in a channel having a bandwidth of about 1 MHz.

19. The apparatus of claim 17, wherein the at least one field is transmitted using binary phase-shift keying (BPSK) and a coding rate of ½.

20. The apparatus of claim 17, wherein the means for transmitting the at least one bit is configured to transmit, via the first antenna, the at least one bit at a first frequency and wherein the means for transmitting the replica of the at least one bit is configured to transmit, via the second antenna, the replica of the at least one bit at a second frequency.

21. The apparatus of claim 20, wherein the first frequency is above DC and wherein the second frequency is below DC.

22. The apparatus of claim 17, further comprising:
means for transmitting, via the first antenna, a first bit of the at least one field at a first frequency;
means for transmitting, via the second antenna, a replica of the first bit at the first frequency;
means for transmitting, via the second antenna, a second bit of the at least one field at a second frequency; and
means for transmitting, via a third antenna, a replica of the second bit at the second frequency.

23. The apparatus of claim 22, further comprising:
means for transmitting, via the third antenna, a third bit of the at least one field at a third frequency; and
means for transmitting, via the first antenna, a replica of the third bit at the third frequency.

24. The apparatus of claim 17, wherein the at least one field comprises at least one of a signal (SIG) field or a short training field (STF).

25. A computer-program product for wireless communications, comprising a computer-readable medium having instructions executable to:
generate a frame comprising a preamble having at least one field;
replicate at least one bit of the at least one field to form a replica of the at least one bit;
transmit the at least one bit via a first antenna; and
transmit the replica of the at least one bit via a second antenna.

26. An apparatus for wireless communications, comprising:
a first antenna;
a second antenna;
a processing system configured to:
generate a frame comprising a preamble having at least one field; and
replicate at least one bit of the at least one field to form a replica of the at least one bit; and
a transmitter configured to:
transmit, via the first and second antennas, the at least one bit at a first frequency;
transmit, via the first antenna, the replica of the at least one bit at a second frequency; and
transmit, via the second antenna, a negative of the replica of the at least one bit at the second frequency.

27. The apparatus of claim 26, wherein the transmitter is configured to transmit the frame in a channel having a bandwidth of about 1 MHz.

28. The apparatus of claim 26, wherein the transmitter is configured to transmit the at least one field using binary phase-shift keying (BPSK) and a coding rate of ½.

29. The apparatus of claim 26, wherein the first frequency is above DC and wherein the second frequency is below DC.

30. The apparatus of claim 26, wherein the at least one field comprises at least one of a signal (SIG) field or a short training field (STF).

31. A method for wireless communications, comprising:
generating a frame comprising a preamble having at least one field;
replicating at least one bit of the at least one field to form a replica of the at least one bit;
transmitting, via a first antenna and a second antenna, the at least one bit at a first frequency;
transmitting, via the first antenna, the replica of the at least one bit at a second frequency; and
transmitting, via the second antenna, a negative of the replica of the at least one bit at the second frequency.

32. The method of claim 31, wherein the frame is transmitted in a channel having a bandwidth of about 1 MHz.

33. The method of claim 31, wherein the at least one field is transmitted using binary phase-shift keying (BPSK) and a coding rate of ½.

34. The method of claim 31, wherein the first frequency is above DC and wherein the second frequency is below DC.

35. The method of claim 31, wherein the at least one field comprises at least one of a signal (SIG) field or a short training field (STF).

36. An apparatus for wireless communications, comprising:
means for generating a frame comprising a preamble having at least one field;
means for replicating at least one bit of the at least one field to form a replica of the at least one bit;
means for transmitting, via a first antenna and a second antenna, the at least one bit at a first frequency;
means for transmitting, via the first antenna, the replica of the at least one bit at a second frequency; and
means for transmitting, via the second antenna, a negative of the replica of the at least one bit at the second frequency.

37. The apparatus of claim 36, wherein the frame is transmitted in a channel having a bandwidth of about 1 MHz.

38. The apparatus of claim 36, wherein the at least one field is transmitted using binary phase-shift keying (BPSK) and a coding rate of ½.

39. The apparatus of claim 36, wherein the first frequency is above DC and wherein the second frequency is below DC.

40. The apparatus of claim 36, wherein the at least one field comprises at least one of a signal (SIG) field or a short training field (STF).

41. A computer-program product for wireless communications, comprising a computer-readable medium having instructions executable to:
generate a frame comprising a preamble having at least one field;
replicate at least one bit of the at least one field to form a replica of the at least one bit;
transmit, via a first antenna and a second antenna, the at least one bit at a first frequency;
transmit, via the first antenna, the replica of the at least one bit at a second frequency; and
transmit, via the second antenna, a negative of the replica of the at least one bit at the second frequency.

42. An apparatus for wireless communications, comprising:
a first pair of antennas;
a second pair of antennas;
a processing system configured to generate at least two space-time streams; and
a transmitter configured to:
transmit, via the first pair of antennas, the at least two space-time streams in a first frequency band; and
transmit, via the second pair of antennas, the at least two space-time streams in a second frequency band.

43. The apparatus of claim 42, further comprising a third pair of antennas, wherein the transmitter is further configured to transmit, via the third pair of antennas, the at least two space-time streams in a third frequency band.

44. The apparatus of claim 43, wherein the first pair of antennas comprises a first antenna and a second antenna, wherein the second pair of antennas comprises the second antenna and a third antenna, and wherein the third pair of antennas comprises the third antenna and the first antenna.

45. The apparatus of claim 42, wherein the first frequency band is above DC and wherein the second frequency band is below DC.

46. A method for wireless communications, comprising:
generating at least two space-time streams;
transmitting, via a first pair of antennas, the at least two space-time streams in a first frequency band; and
transmitting, via a second pair of antennas, the at least two space-time streams in a second frequency band.

47. The method of claim 46, further comprising transmitting, via a third pair of antennas, the at least two space-time streams in a third frequency band.

48. The method of claim 47, wherein the first pair of antennas comprises a first antenna and a second antenna, wherein the second pair of antennas comprises the second antenna and a third antenna, and wherein the third pair of antennas comprises the third antenna and the first antenna.

49. The method of claim 46, wherein the first frequency band is above DC and wherein the second frequency band is below DC.

50. An apparatus for wireless communications, comprising:
means for generating at least two space-time streams;
means for transmitting, via a first pair of antennas, the at least two space-time streams in a first frequency band; and
means for transmitting, via a second pair of antennas, the at least two space-time streams in a second frequency band.

51. The apparatus of claim 50, further comprising means for transmitting, via a third pair of antennas, the at least two space-time streams in a third frequency band.

52. The apparatus of claim 51, wherein the first pair of antennas comprises a first antenna and a second antenna, wherein the second pair of antennas comprises the second antenna and a third antenna, and wherein the third pair of antennas comprises the third antenna and the first antenna.

53. The apparatus of claim 50, wherein the first frequency band is above DC and wherein the second frequency band is below DC.

54. A computer-program product for wireless communications, comprising a computer-readable medium comprising instructions executable to:
generate at least two space-time streams;
transmit, via a first pair of antennas, the at least two space-time streams in a first frequency band; and
transmit, via a second pair of antennas, the at least two space-time streams in a second frequency band.

55. An access point, comprising:
a first pair of antennas;
a second pair of antennas;
a processing system configured to generate at least two space-time streams;
a transmitter configured to:
transmit, via the first pair of antennas, the at least two space-time streams in a first frequency band; and
transmit, via the second pair of antennas, the at least two space-time streams in a second frequency band; and
a memory component configured to store the at least two space-time streams before transmission.

56. An access point, comprising:
a first antenna;
a second antenna;
a processing system configured to:
generate a frame comprising a preamble having at least one field; and
replicate at least one bit of the at least one field to form a replica of the at least one bit;
a transmitter configured to:
transmit the at least one bit via the first antenna; and
transmit the replica of the at least one bit via the second antenna; and
a memory component configured to store the frame before transmission.

57. An access point, comprising:
a first antenna;
a second antenna;
a processing system configured to:
generate a frame comprising a preamble having at least one field; and
replicate at least one bit of the at least one field to form a replica of the at least one bit;
a transmitter configured to:
transmit, via the first and second antennas, the at least one bit at a first frequency;
transmit, via the first antenna, the replica of the at least one bit at a second frequency; and
transmit, via the second antenna, a negative of the replica of the at least one bit at the second frequency; and
a memory component configured to store the frame before transmission.
